(19) United States
(12) Patent Application Publication
(10) Pub. No.: US 2026/0141085 A1
(43) Pub. Date: May 21, 2026

(54) DATA TRANSFER SYSTEM

(71) Applicant: American Express Travel Related Services Company, Inc., New York, NY (US)

(72) Inventors: Rohit TANEJA, Gurgaon (IN); Mikul GARG, Gurugram (IN); Rachna TAKKAR, Gurugram (IN); Sachin BANSAL, New Delhi (IN); Sunil KUMAR, Ghaziabad (IN); Tarun MADAAN, New Delhi (IN)

(73) Assignee: American Express Travel Related Services Company, Inc., New York, NY (US)

(21) Appl. No.: 18/948,872

(22) Filed: Nov. 15, 2024

(51) Int. Cl. G06F 21/60; G06F 16/21

(52) U.S. Cl. CPC G06F 21/602; G06F 16/211

(57) ABSTRACT

Disclosed herein are system, method, and computer program product embodiments for improving data transfer systems by using a data loader system configured to utilize a thread pool to encrypt and send data formatted according to a schema. A data loader system may receive identification of source data at a transfer source system that is formatted according to a source schema. The data loader system may further receive identification of a target data location at a transfer target system. Data at the target data location may be formatted according to a target schema. The data loader system may validate the source and target schemas by comparing a field in the source schema to a field in the target schema. In response to the validation, the data loader system may encrypting and transfer the source data to the target data location.

### BACKGROUND

### Field

This field is generally related to improved data transfer systems and methods.

### Related Art

In some enterprise computing environments, data is often transferred between entities. For example, a bank may need to transfer all of its customer's transaction data from a first storage site to a second storage site in order to comply with data governance requirements. Similarly, a retailer may transfer inventory and sales data as part of a backup process. As data transfers become larger and more complex, they consume additional computing resources for longer periods of time. Additionally, the data involved in the transfer may be inaccessible while the transfer is occurring. Further complexity is introduced when the data source and data target are stored in different formats. For example, it may take longer and require more computing resources to transfer data between a SQL database and a Hadoop cluster, than transferring data between two SQL databases.

### BRIEF SUMMARY

Disclosed herein are system, apparatus, device, method and/or computer program product embodiments, and/or combinations and sub-combinations thereof, for improving the performance of data transfers. This disclosure describes a data loader system configured to transfer data from a first storage device to a second storage device. The data loader system is configured to compare schemas determining how the data at the source and target are stored. The data loader system is further configured to use one or more aliases in order to map data fields with different schema definitions. The data loader system is further configured to leverage encryption to protect data in transit.

### BRIEF DESCRIPTION OF THE DRAWINGS

The accompanying drawings are incorporated herein and form a part of the specification.

FIG. 1 depicts a block diagram of a transfer environment, according to some embodiments.

FIG. 2 depicts a block diagram illustrating aliasing a schema, according to some embodiments.

FIG. 3 depicts a block diagram illustrating mapping a source schema to a target schema, according to some embodiments.

FIG. 4 depicts a flowchart diagram illustrating a method for utilizing a data loader system, according to some embodiments.

FIG. 5 depicts a flowchart illustrating a method for utilizing a data loader system, according to some embodiments.

FIG. 6 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for improving the performance of data transfers. Upon receiving a data transfer request, a data loader system may compare schemas corresponding to source data and the location of where the data is to be transferred. The data loader system may employ an alias to map different fields within the schemas. The data loader system may further employ encryption to protect the data.

Current data transfer systems may consume vast amounts of computing resources during a transfer. Additionally, these systems may be unable to perform transfers between different systems, such as between an Apache Hadoop cluster and a SQL database. Even if the systems schemas do match (e.g., two SQL databases), current systems may fail to execute a transfer when fields in data source are not present in the transfer target. For example, a current system may fail to transfer data between two SQL database tables when a field in the source table is missing in the target table. These systems may also introduce security concerns based on their inability to encrypt data. As a result, a malicious third party may be able to capture unencrypted data as it's transferred through a network.

To address such issues, a data loader system is described herein. The data loader system may be configured to receive a transfer request. The transfer request may specify a transfer source such as a Hadoop cluster or a SQL database. The transfer request may further include a location within the source such as a file at the Hadoop cluster or a table within the SQL database. The data loader system may further be configured to evaluate schemas defining how the source and transfer data are formatted. For example, the data loader system may compare fields within each schema to determine whether any fields are absent. If any fields are absent between the schemas, the data loader system may use an alias to map fields. For example, the alias may determine that field A at the source maps to field B at the target. The schema evaluation process may also involve comparing the format of the stored data to determine whether the data needs to be converted to a specific format prior to executing the transfer. For example, source data stored as strings may be converted to integers prior to executing the transfer.

The data loader system may further leverage encryption to protect the data sent during the transfer. The data loader system may leverage symmetric encryption, asymmetric encryption, or a combination thereof. The data loader system may further utilize multiple threads. For example, the data loader system may execute multiple threads to encrypt the data and send it to the target system. Once the data is sent, the data loader system may verify the data has been successfully written to the target. For example, the data loader system may compare cryptographic hashes calculated based on the data to be transferred, and the data written to the target, in order to determine whether all the data was transferred. The data loader system may report the results of the transfer.

Various embodiments of these features will now be discussed with respect to the corresponding figures.

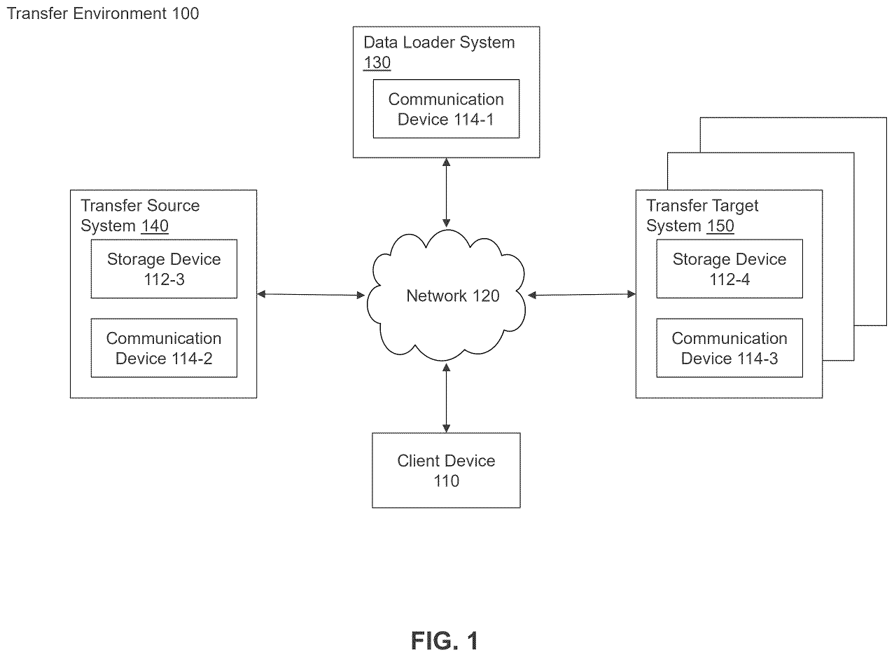

FIG. 1 depicts a block diagram of a transfer environment 100, according to some embodiments. Transfer environment 100 includes client device 110, network 120, data loader system 130, transfer source system 140, and transfer target system 150.

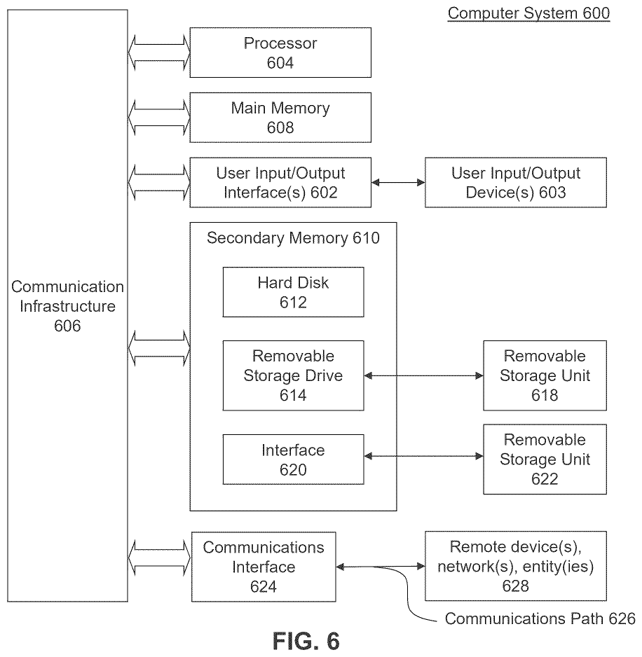

Client device 110 may be any entity on network 120. Client device 104 may be a computer system such as computer system 600 described with reference to FIG. 6. Client device 110 may be a client system such as a desktop workstation, laptop or notebook computer, netbook, tablet, smart phone, and/or other computing device that may be using an enterprise computing system.

Client device 110 may also be configured to interact with data loader system 130, transfer source system 140, and/or transfer target system 150. For example, client device 110 may be configured to access data at transfer source system 140. Additionally, client device 110 may be configured to cause data loader system 130 to execute a data transfer between transfer source system 140 and transfer target system 150.

Network 120 may be any type of computer or telecommunications network capable of communicating data, for example, a local area network, a wide-area network (e.g., the Internet), or any combination thereof. The network may include wired and/or wireless segments. In some embodiments, network 120 may be a secure network. In some embodiments, client device 110 may reside within network 120. In some embodiments, client device 110 may reside outside network 120.

Data loader system 130 may be configured to interact with entities on network 120 such as client device 110, transfer source system 140, and transfer target system 150. Data loader system 130 may be implemented using one or more servers and/or databases. In some embodiments, data loader system 130 may be implemented using a computing device such as a desktop workstation, laptop or notebook computer, netbook, tablet, smart phone, and/or other computing device. In some embodiments, data loader system 130 may be implemented as an application in an enterprise computing system and/or a cloud-computing system. In some embodiments, data loader system 130 may be a computer system such as computer system 600 described with reference to FIG. 6.

In some embodiments, data loader system 130 may be implemented as an application. For example, data loader system 130 may be implemented as an executable application on a computer. Similarly, data loader system may be implemented as a mobile application configured to execute on a smartphone. As will be discussed above, data loader system 130 may only require a few variables to execute a data transfer. As a result, data loader system 130 may be plug and play, requiring minimal setup from a user.

Data loader system 130 may include communication device 114-1. Communications device 114 may comprise any suitable network interface capable of transmitting and receiving data, such as, for example a modem, an Ethernet card, a communications port, or the like. Communications device 114 may be able to transmit data using any wireless transmission standard such as, for example, Wi-Fi, Bluetooth, cellular, or any other suitable wireless transmission.

Data loader system 130 may perform a data transfer from transfer source system 140 to transfer target system 150. Although data transfers may be discussed as going from transfer source system 140 to transfer target system 150, data may be transferred from transfer target system 150 to transfer source system 140.

Transfer source system 140 may be configured to store data. In some embodiments, transfer source system 140 may be implemented using a memory storage device. Transfer source system 140 may store data in various formats. For example, transfer source system 140 may include a Hadoop cluster, a SQL database, or any combination thereof to store data. Transfer source system 140 may support any file type such as PARQUET files, ORC files, and record columnar files. Transfer source system 140 may store data according to a schema. A schema may define categories of data stored and the format of the data. For example, a SQL database may include a table storing data regarding one or more bank accounts. A schema may include the types of data stored in the table (e.g., user identifier, account type, and balance). The schema may further include a format of each data type. For example, a user identifier may be formatted as any alphanumeric character and a balance may be a floating point value.

Transfer source system 140 may include communications device 114-2 to communicate with entities on network 120. For example, client device 110 may communicate with transfer source system 140 to access data at transfer source system 130. In some embodiments, client device 110 may interact with data loader system 130 to cause data at transfer source system 140 to transfer target system 150.

Transfer target system 150 may be configured to store data. In some embodiments, transfer target system 150 may be implemented using a memory storage device In some embodiments, transfer target system 150 maybe a Hadoop cluster, a SQL database, or a combination thereof. Transfer target system 150 may support any file type such as PARQUET files, ORC files, and record columnar files. Similar to transfer source system 140, transfer target system 150 may include one or more schemas defining the format of stored data.

Data loader system 130 may initiate a data transfer based on an indication from client device 110. For example, client device 110 may make a call to an application programming interface (API) at data loader system 130 to initiate a transfer. In some embodiments, client device 110 may access a webpage hosted by data loader system 130. A user associated with client device 110 may interact with the webpage via client device 110 to initiate the transfer. As discussed above, in some embodiments, data loader system 130 may be implemented as an executable program (e.g., application, mobile application) on client device 110. In some embodiments, client device 110 may interact with data loader system 130 via a command line interface. For example, a user of client device 110 may initiate a transfer by inputting a single command to a command line interface connected to data loader system 130. As will be discussed below, a transfer may be associated with one or more variables. For example, a variable may be used to determine a transfer source system 130 and a transfer target system 150. Here, client device 110 call the command at the command line interface and include one or more variables in the command. For example, client device 110 may input the command at the command line interface along with a parameter (e.g., variable) identifying data at transfer source system 130 to transfer. In some embodiments, variables to configure the transfer may be stored in a configuration file. Here, client device 110 may call the command at the command line interface and include, as a parameter, a file path to the configuration file including the variables to configure the transfer.

In some embodiments, data loader system 130 may require client device 110 to submit authentication credentials prior to initiating the transfer. For example, if data loader system 130 is unable to authenticate client device 110 via submitted credentials, data loader system 130 may not initiate the transfer

One or more variables may be used to configure the transfer. The variables may be stored within a configuration file at data loader system 130. In some embodiments, data loader system 130 may utilize a set of variables within a default configuration file. In some embodiments, client device 110 may include one or more variables in a transfer request to data loader system 130. For example, when data loader system 130 receives a transfer request from client device 110, it may create a configuration file including variables specified by client device 110. Default variables may be used for variables not specified by client device 110. Variables may include, but are not limited to: (i) a transfer source (e.g., transfer source system 140); (ii) identification of the source data at transfer source system 140 (e.g., a file path); (iii) the source schema; (iv) a transfer target (e.g., transfer target system 150); (v) a location at the transfer target system (e.g., a file path); (vi) a target schema; (vii) an encryption field, (viii) a repeat field; (ix) an overwrite field; and (x) retry attempts. In some embodiments, variables may also include a usecase name and an application name.

The transfer source may indicate an entity on network 120 to transfer the data from. The transfer source may be transfer source system 140. Identification of the source data at the transfer source (e.g., transfer source system 140) may be where the data to be transferred by data loader system 130 is residing. For example, the identification of the source data may be a file path to a Hadoop cluster, a SQL database, a file or any other data storage identifier. In some embodiments, identification of the source data may be more granular. For example, the transfer request may include specific fields, such as identification of specific columns within a SQL table, to send via the transfer.

As will be discussed below, data at transfer source system 140 and transfer target system 150 may be formatted according to schemas. The source schema variable may be used to identify how the data to be transferred is formatted. The source schema variable may be a file path to the source schema accessible by data loader system 130. In some embodiments, the source schema may be defined within the source schema variable. For example, the source schema may be defined within a JSON object included within the source schema variable.

The transfer target may be an entity on network 110 to send the data. The transfer target may be transfer target system 150. In some embodiments, the transfer target may include multiple systems. For example, the transfer target variable may list transfer target system 150-1, transfer target system 150-2, and transfer target system 150-3. Transferring data to multiple transfer targets (e.g., tables) may be beneficial in a scenario where data needs to be backed and there is a risk that if the data is stored at a single location, it may be lost.

The location at the transfer target may be file path or other indicator of where, at transfer target, to store the data. For example, the location may be a specific SQL database, a specific Hadoop cluster, a specific file, or any combination thereof. Similar to the source schema, the target schema may identify how data at the transfer target location is formatted.

An encryption field may indicate whether to encrypt the data prior to performing the transfer. The encryption field may further specify an encryption mechanism. For example, data loader system 130 and transfer target system 150 may each have a shared key used to encrypt and decrypt data. Here, data loader system 130 may encrypt the source data at transfer source system 140 and send the encrypted source data to transfer target system 150. Subsequently, transfer target system 150 may decrypt the received, encrypted source data using the shared key. In some embodiments, the encryption field may specify to use an asymmetric cryptographic scheme such as via public and private keys. Here, transfer target system 150 may have a public key and a private key. As a result, data loader system 130 may encrypt the source data at transfer source system 140 with the public key of transfer target system 150 and send the encrypted source data to transfer target system 150. Once received, transfer target system 150 may decrypt the encrypted source data using its private key.

As will be discussed below, data loader system 130 may include a thread pool configured to store one or more execution threads. The execution threads may be utilized to perform various tasks such as the data transfer. The one or more execution threads at the thread pool may also be used during encryption. For example, each of the one or more threads may be configured to encrypt a subset of the source data as described above. This may be beneficial to improve performance and decrease processing times.

A repeat field may be used to specify whether to repeat the transfer, and if so, how often. For example, client device 110 may utilize data loader system 130 to perform transfers as part of a backup process. In order to streamline the process, client device 110 may use the repeat field to indicate that the transfer should repeat once per day, once per week, etc.

An overwrite field may be used to indicate how data loader system 130 is to write data (e.g., source data from transfer source system 140) to transfer target system 150. In some embodiments, the overwrite field may be a Boolean. When false, data loader system 130 may append the data transferred to the location at transfer target system 150. For example, if the overwrite field is false and data is to be transferred to a SQL database, data loader system 130 may append the transferred data to the SQL database such that the data already stored at the SQL database is unaffected. If the overwrite field is true, data loader system 130 may create a copy of data at the location of transfer target system 150, and write the transferred data to the copy. As a result, transfer target system 150 may include two copies of data, one copy including data prior to the transfer and a second copy including data post transfer.

The retry attempts field may be used when a transfer fails. As will be discussed below, data loader system 130 may verify the results of a data transfer. In some embodiments, part or all of the data may not be transferred to transfer target system 150. Here, retry attempts may be a value indicating the number of subsequent attempts to re-transfer the data. For example, if the retry attempts field is three, data loader system 130 may reattempt the transfer up to three times. Similar to the other variable discussed, client device 110 may define the retry attempts field in its transfer request.

As discussed above, data loader system 130 may utilize default variables to execute a transfer. For example, client device 110 may send a transfer request only including the source system, source system data, target system, and a location at the target system. As a result, data loader system 130 may utilize default values for the remaining variables.

Client device 110 may specify variables by including one or more variables with the transfer request. For example, as part of an API call to initiate the transfer, the API call may include indication identification of the source data at the transfer source system (e.g., a table within a SQL database at transfer source system 140) and a location at a transfer target system (e.g., a Hadoop cluster at transfer target system 150). Data loader system 130 may utilize default variables for variables not specified by client device 110. For example, data loader system 130 may, as a default, encrypt data prior to transferring it.

Data loader system 130 may store the one or more variables in a configuration file. Data loader system 130 may delete the configuration file once a transfer has completed. In some embodiments, data loader system 130 may retain configuration files for future reference. For example, if client device 110 sends a transfer request with the repeat variable set to true, data loader system 130 may generate and save the configuration file so that it may be referenced when the transfer is repeated.

As discussed above, data loader system 130 may receive an indication of data to transfer from transfer source system 140 to transfer target system 150 (e.g., source data). Data loader system 130 may identify schemas corresponding to the transfer source and the transfer target. As will be discussed in more detail below, data loader system 130 may validate the source and target schemas by performing a validation process. This is beneficial so that data loader system 130 knows where, within the location at the target system, to transfer the data. For example, the schema validation process may indicate which SQL database columns data should be written to at transfer target system 150.

In some embodiments, data loader system 130 may encrypt the source data prior to executing the transfer. As discussed above, this may be accomplished via symmetric cryptography using a shared key, asymmetric cryptography using a public-private key pair, or any other cryptographic scheme. In some embodiments, multiple levels of encryption may be utilized. For example, the source data may be first be encrypted using a shared key. The results of the first encryption may then be encrypted using a public key corresponding to transfer target system 150. Once the encrypted source data is generated, data loader system 130 may proceed with the transfer.

In some embodiments, data loader system 130 may perform the transfer using a pool of execution threads. The thread pool may include any number of execution threads. Each execution thread may be configured to transfer a subset of the data. Data loader system 130 may determine a number of threads to execute based on a size of the data to be transferred, a type of data to be transferred, a number of transfer target systems 150, or a combination thereof. For example, data loader system 130 may execute additional threads when transferring 2 TB of data than 5 GB of data. Similarly, the transfer request may include an indication to transfer the data to multiple transfer target systems 150. In response, data loader system 130 may execute one or more threads, where each of the one or more threads is assigned to a transfer target system 150. Data loader system 130 may send the data via network 120. By utilizing multiple threads, data loader system 130 may be able to execute the transfer faster than current systems. Additionally, once a thread transfers the subset of data assigned to it, the data at transfer source system 140 may be freed up.

For example, in a current transfer system, the entirety of the data to be transferred may be inaccessible while the transfer is occurring. In contrast, by utilizing multiple threads, each subset of the data transferred by a thread may be freed up at transfer source system 140. Thus, once a thread transfers its subset of the data, the subset of the data may be accessed by other processes.

In some embodiments, data loader system 130 may execute the transfer in real-time. For example, data loader system 130 may execute the transfer once the transfer request is received from client device 110. In some embodiments, data loader system 130 may be configured to execute the transfer as part of a batch process. For example, data loader system 130 may execute the transfer request once a predefined number of transfer requests are received. In some embodiments, the predefined number may correspond to a single transfer source system 140. This may be beneficial in a scenario where multiple entities (e.g., client device 110) access data at transfer source system 140. By batching the transfer requests and executing them together, as opposed to when they are received, the impact on data availability at transfer source system 140 is minimized. In some embodiments, data loader system 130 may execute a batch process based on the amount of data to be transferred. For example, data loader system 130 may queue transfer requests until the total amount of data to be transferred passes a predefined threshold (e.g., 10 TB). Once the threshold is passed, data loader system 130 may execute each of the queued transfer requests (e.g., the batch). Again, this may be beneficial to reduce the impact that serially executing transfers may have on the availability of data and resources at transfer source system 140. In some embodiments, the batch process may be based on transfer target system 150. For example, transfer requests may indicate data to be transferred from multiple transfer source systems 140 to a single transfer target system 150. Similar to the discussion above, data loader system 130 may queue the requests until a condition relating to transfer target system 150 is met (e.g., a number of transfer requests, or an amount of data to be written to transfer target system 150).

In some embodiments, data loader system 130 may verify the transfer. For example, data loader system 130 may compare an amount of data to be transferred at transfer source system 140 to the amount of data written to transfer target system 150. In some embodiments, data loader system 130 may verify the content of the transfer. For example, data loader system 130 may calculate a hash of the content to be transferred at transfer source system 140. After the transfer, data loader system 130 may calculate a hash of the data transferred to transfer target system 150. Data loader system 130 may compare the calculated hashes. If the hashes are the same, this may indicate that all the data to be transferred was in fact transferred. If the hashes differ, this may indicate that some data was not transferred, data was changed during the transfer, or a combination thereof. Data loader system 130 may transmit results of the verification to the entity that requested the transfer (e.g., client device 110). In some embodiments, data loader system 130 may be configured to automatically retry the transfer if the hashes differ. Data loader system 130 may include a variable determining how many retry attempts to make. For example, data loader system 130 may be configured to retry a transfer up to three times. In some embodiments, client device 110 may indicate to data loader system 130 to retry the transfer a specific number of times. Client device 110 may indicate a number of retry attempts as a variable in the transfer request.

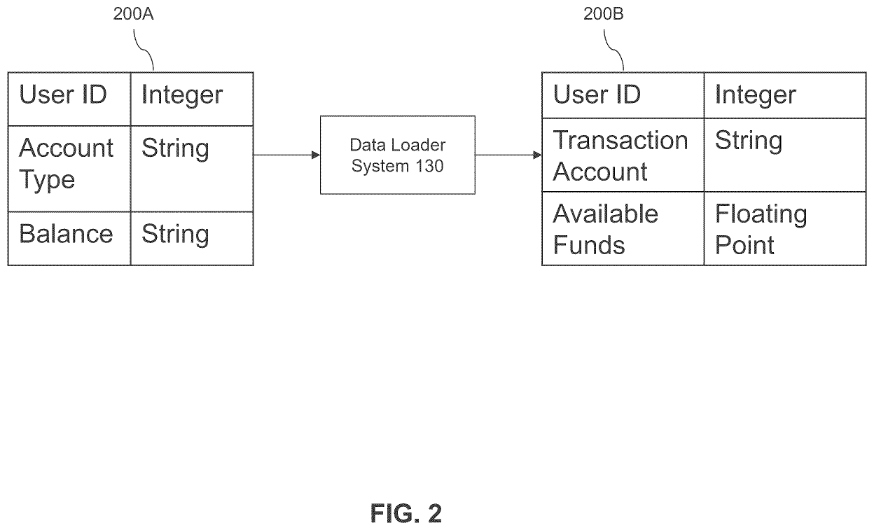

FIG. 2 depicts a block diagram illustrating aliasing schema 200, according to some embodiments. As discussed above, data at transfer source system 140 and/or transfer target system 150 may be formatted according to a schema. The schema may list categories of data for a storage location. For example, schema 200A may correspond to a table within a SQL database at transfer source system 140 and include fields such as “User ID,” “Account Type,” and “Balance.” Schema 200A may include formats for each field. For example, values under “User ID” may be integers whereas values under “Account Type” and “Balance” may be strings. Similarly, schema 200B may correspond to a table within a SQL database at transfer target system 150. Here, schema 200B may include fields such as “User ID,” “Transaction Account,” and “Available Funds.” Values under “User ID” and “Available Funds” may be represented as floating point and data under “Available Funds” may be represented as strings.

When data loader system 130 initiates a transfer, it may validate schema 200A corresponding to the source data to be transferred (e.g., data at transfer source system 140) and schema 200B at the transfer destination (e.g., the location at transfer target system 150). Data loader system 130 may validate the schemas by comparing the list of data categories within each schema. For example, data loader system 130 may determine whether each data category in the source schema is present in the target schema. Data loader system 130 may generate a data structure including a mapping of data categories at the transfer source to data categories at the transfer target. The data categories may be identified via the source and target schemas. Data loader system 130 may further compare the formats for each data category match. As an example, data loader system 130 may determine that “User ID” is present in both the source schema (e.g., schema 200A) and the target schema (schema 200B). Data loader system 130 may then determine whether each “User “ID” has the same format. As a result, data loader system 130 may indicate in the data structure that “User ID” maps to “User ID,” and both are formatted as integers.

In some embodiments, data categories in the source and target schemas may differ. For example, a data category in the source schema may not be included in the target schema. Here, data loader system 130 may apply an alias to map data categories between transfer source system 140 and transfer target system 150. In some embodiments, client device 110 may send an alias to data loader system 130. In some embodiments, data loader system 130 may include a default alias.

Data loader system 130 may reference the alias when a data category in schema 200A at the transfer source system 140 is not present in the schema 200B at transfer target system 150. For example, as depicted in FIG. 2, schema 200A includes “Account Type” but schema 200B does not. Data loader system 130 may refer to the alias and determine that “Account Type” maps to “Transaction Account.” As a result, data loader system 130 may apply the alias by writing this mapping to the data structure referenced for the transfer. In some embodiments, data loader system 130 may determine a data category discrepancy that is not defined in the alias. For example, schema 200A may include a data category not present in both schema 200B and the alias. Here, data loader system 130 may request an alias from client device 110. For example, data loader system 130 may send an alert via network 120 to client device 110, requesting an alias for the data category. Once received from client device 110, data loader system 130 may apply the alias by writing the mapping in the alias to the data structure used in the transfer.

As noted above, data loader system 130 may further compare the format for each data category. For example, once data loader system 130 constructs the data structure identifying the mapping of each data category in schema 200A at transfer source system 140 to schema 200B at transfer target system 150, data loader system 130 may determine whether the mapped data categories have matching formats. If the formats are the same, data loader system 130 may use the matching format. For example, data loader system 130 may write in the data structure that “User ID” is formatted as an integer because both schema 200A and schema 200B use integers for “User ID.” If the formats differ, data loader system 130 may use the format of transfer target system 150. Thus, data loader system 130 may use the format listed in schema 200B for the transfer. For example, data loader system 130 may determine, via the alias that “Balance” maps to “Available Funds.” Data loader system 130 may further determine that the formats do not match since “Balance” is stored as a string and “Available Funds” is stored as a floating point value. Here, data loader system 130 may apply the alias and convert the data under the “Balance” category to floating point numbers prior to storing them at transfer target system 150.

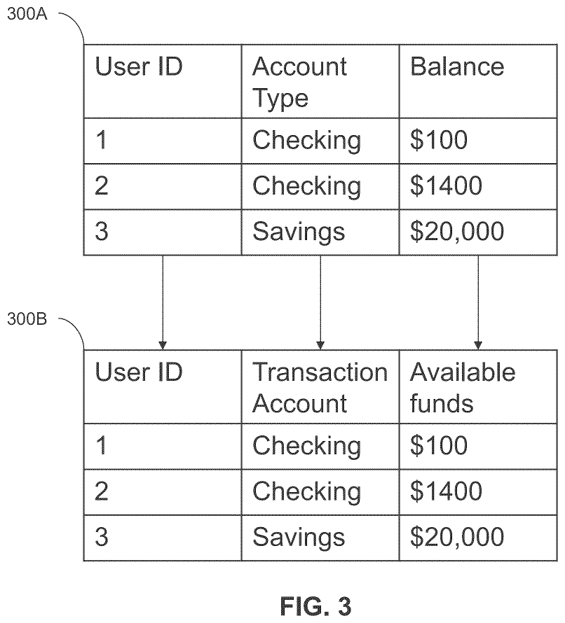

FIG. 3 depicts a block diagram illustrating mapping a source schema 300A to a target schema 300B, according to some embodiments. As discussed above, a schema may be used to describe how data is stored at a transfer source (e.g., transfer source system 140) and at a transfer target (e.g., transfer target system 150). As discussed above with reference to FIG. 2, data loader system 130 may apply an alias to map categories of data within source schema 300A to data categories within target schema 300B. As shown in FIG. 3, data loader system 130 may apply an alias to determine that data under “Account Type” should be transferred under the data category “Transaction Account.” Data loader system 130 may apply the alias to make a similar determination for “Balance” and “Available Funds.”

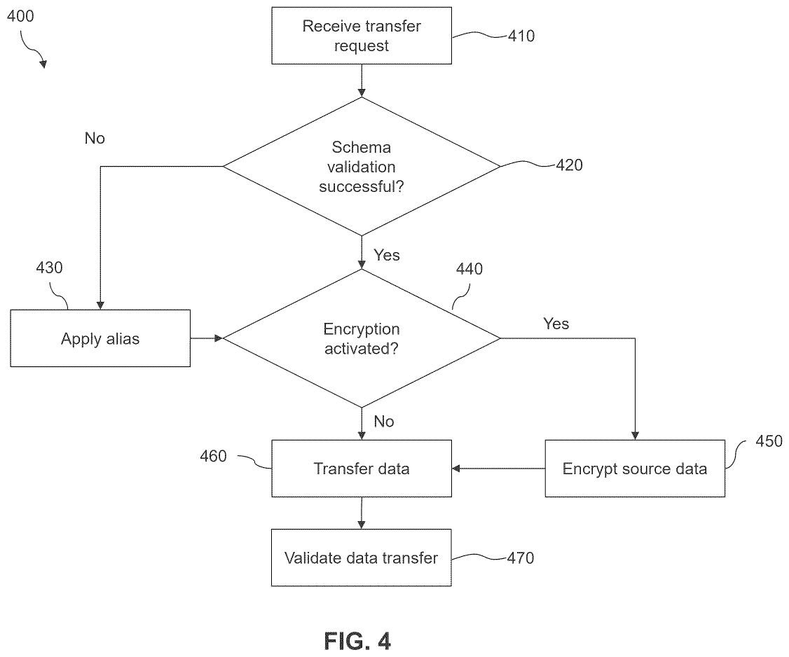

FIG. 4 depicts a flowchart 400 diagram illustrating a method for utilizing a data loader system, according to some embodiments. Flowchart 400 shall be described with reference to FIG. 1, however, flowchart 400 is not limited to that example embodiment.

In an embodiment, data loader system 130 may use flowchart 400 to transfer data from transfer source system 140 to transfer target system 150. The foregoing description will describe an embodiment of the execution of flowchart 400 with respect to data loader system 130. While flowchart 400 is described with reference to data loader system 130, flowchart 400 may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 4.

At 410, data loader system 130 receives a transfer request. Data loader system 130 may receive the transfer request from client device 110. In some embodiments, data loader system 130 may be a command line utility on client device 110. Here, the transfer request may be received via a command line interface at client device 110. In some embodiments, the transfer request may include a variable to configure the transfer request. For example, a variable may specify data to transfer (e.g., source data at transfer source system 140).

At 420, data loader system 130 determines whether schema validation was successful. As discussed above, source data to be transferred from transfer source system 140 may be formatted according to a schema. Similarly, the location at transfer target system 150 to write the data may also be formatted according to a schema. Data loader system 130 may validate the schemas (e.g., the source schema and the target schema) by comparing one or more fields and one or more formats within the schemas. If the fields and formats match, flowchart 400 may proceed to 440. If there is a difference in the schemas, flowchart 400 may proceed to 430.

At 430, data loader system 130 applies an alias to map the source schema to the target schema. As discussed above, a field in the source schema may not be present in the target schema. As a result, data loader system 130 may apply an alias to map the field in the source schema to a field that is present in the target schema. Similarly, data loader system 130 may apply the alias to map a format of a field in the source schema to a format of a field in the target schema.

At 440, data loader system 130 determines whether encryption is activated. Data loader system 130 may determine whether encryption is activated by referencing a configuration file including an encryption variable. In some embodiments, data loader system 130 may query client device 110 to determine whether encryption is activated. If encryption is activated, flowchart 400 may proceed to 450. If encryption is not activated, flowchart 400 may proceed to 460.

At 450, data loader system 130 encrypts the source data to generate encrypted source data. In some embodiments, data loader system 130 may use a shared key associated with transfer target system 150, a public key associated with transfer target system 150, or a combination thereof, to encrypt the source data.

At 460, data loader system 1430 transfers the source data to transfer target system 150. In some embodiments, data loader system 130 may execute one more ore threads to perform the transfer. The number of threads may be based on a size of the data transferred, a type of data to be transferred, a number of transfer target systems, or any combination thereof.

At 470, data loader system 130 validates the data transfer. Data loader system 130 may use various mechanisms to validate the transfer. In some embodiments, data loader system 130 may compare a size of data to be transferred with a size of data written to transfer target system 150. In some embodiments, data loader system 130 may calculate a hash of data to be transferred. Data loader system 130 may similarly calculate a hash of data written to transfer target system 150. Data loader system 130 may compare the hashes to determine whether all the data was successfully transferred.

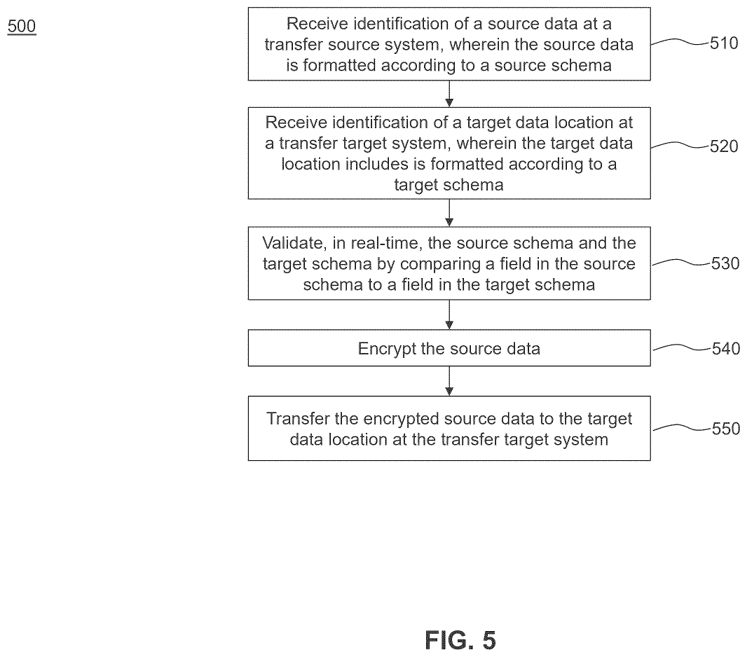

FIG. 5 depicts a flowchart illustrating a method 500 for transferring data, according to some embodiments. Method 500 shall be described with reference to FIG. 1, however, method 500 is not limited to that example embodiment.

In an embodiment, data loader system 130 may use method 500 to transfer data from transfer source system 140 to transfer target system 150. The foregoing description will describe an embodiment of the execution of method 500 with respect to data loader system 130. While method 500 is described with reference to data loader system 130, method 500 may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 5.

At 510, data loader system 130 receives identification of a source data at transfer source system 140. The source data may be formatted according to a source schema such as schema 200A. Data loader system 130 may receive identification of the source data as part of a transfer request. The transfer request may be received from client device 110 via network 120.

At 520, data loader system 130 receives identification of a target data location at transfer target system 150. The target data location may be formatted according a target schema such as schema 200B. The target data location may be a location within transfer target system 150 to transfer the data. For example, the target data location may be a SQL database or a Hadoop cluster. In some embodiments, the target data location may include a file path. The target data location may be included in a transfer request from client device 110.

At 530, data loader system 130 validates, in real-time, the source schema and the target schema by comparing a field in the source schema to a field in the target schema. Data loader system 130 may query transfer sourced system 140 and transfer target system 150 to retrieve the schemas corresponding to the data source and transfer target locations. In some embodiments, data loader system 130 may determine that a field in the source schema is not present in the target schema. In response, data loader system 130 may apply an alias to map the field in the source schema to a field in the target schema. For example, data loader system 130 may determine that a category “Balance” in the source schema is not in the target schema. Data loader system 130 may refer to the alias to determine that “Balance” maps to “Available Funds” at transfer target system 150. Data loader system may further compare the format of each data category in the schemas. This may be beneficial so that data loader system 130 may convert the format of data during the transfer. For example, “Balance” may be stored as a string, but at transfer target system 150, “Available Fund” may be a floating point. As a result, data loader system 130 may convert the string field to a floating point number prior to storing it at transfer target system 150.

At 540, data loader system 130 encrypts the source data generating an encrypted source data. As discussed above, the transfer request from client device 110 may include a variable indicating whether to encrypt the data to be transferred. In some embodiments, data loader system 130 may use symmetric encryption where a key shared with transfer target system 150 is used to encrypt the data. In some embodiments, asymmetric encryption may be used where a public key corresponding to transfer target system 150 is used to encrypt the data.

At 550, data loader system 130 transfers the encrypted source data to the target data location at transfer target system 150. Data loader system 130 may execute one or more threads to transfer the data to transfer target system 150. In some embodiments, data loader system 130 may append (e.g., add) the transfer data to the location. For example, data loader system 130 may access a table within a SQL database at transfer target system 150 and add the transfer data to the table. In some embodiments, data loader system 130 may be configured to overwrite data at transfer target system 150. Here, data loader system 130 may make a copy of the transfer location (e.g., the file) and write the transfer data to the copy. This may be beneficial to preserve the original data.

Once transferred, the encrypted source data at transfer target system 150 may be decrypted. In some embodiments, data loader system 130 may decrypt the encrypted source data. For example, if a shared key was used to encrypt the source data, data loader system 130 may decrypt the encrypted source data using the shared key. If asymmetric encryption was used, transfer target system 150 may decrypt the encrypted source data using its private key.

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (e.g., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method comprising:
receiving identification of a source data at a transfer source system, wherein the source data is formatted according to a source schema;
receiving identification of a target data location at a transfer target system, wherein the target data location is formatted according to a target schema;
validating, in real-time, the source schema and the target schema by comparing a field in the source schema to a field in the target schema;
in response to the validation, encrypting the source data; and
transferring the encrypted source data to the target data location.

2. The computer implemented method of claim 1, wherein the source data is transferred using a pool of execution threads.

3. The computer implemented method of claim 2, wherein a number of execution threads in the pool is based at least on a size of the data to be transferred, a type of data to be transferred, or a number of transfer target systems.

4. The computer implemented method of claim 1, wherein validating the source scheme and the target schema fails, the method further comprising:
applying an alias configured to match the field in the source schema to the field in the target schema.

5. The computer implemented method of claim 1, further comprising accessing a configuration file, the configuration file comprising: (i) a transfer source; (ii) identification of the source data at the transfer source system; (iii) the source schema; (iv) a transfer target; (v) a location at the transfer target system; (vi) the target schema; (vii) an encryption field, (viii) a repeat field; (ix) an overwrite field; and (x) retry attempts.

6. The computer implemented method of claim 5, wherein the overwrite field is true, the method further comprising:
creating a copy of the data at the location at the transfer target system; and
replacing the copy of the data with the encrypted source data at the transfer target system.

7. The computer implemented method of claim 5, wherein the overwrite field is false, and wherein transferring the encrypted source data to the target data location causes the encrypted source data to be appended to the location at the transfer target system.

8. A system, comprising:
a memory; and
at least one processor coupled to the memory and configured to:
receive identification of a source data at a cluster system, wherein the source data is formatted according to a source schema;
receiving identification of a target data location, wherein the target data location includes an SQL database formatted according to a target schema;
validate, in real-time, the source schema and the target schema by comparing a field in the source schema to a field in the target schema;
in response to the validation, encrypt the source data; and
transfer the encrypted source data to the target data location.

9. The system of claim 8, wherein the source data is transferred using a pool of execution threads.

10. The system of claim 9, wherein a number of execution threads in the pool is based at least on a size of the data to be transferred, a type of data to be transferred, or a number of transfer target systems.

11. The system of claim 8, wherein validating the source scheme and the target schema fails, the at least one processor is further configured to:
apply an alias configured to match the field in the source schema to the field in the target schema.

12. The system of claim 8, wherein the at least one processor is further configured to access a configuration file, the configuration file comprising: (i) a transfer source; (ii) identification of the source data at the transfer source system; (iii) the source schema; (iv) a transfer target; (v) a location at the transfer target system; (vi) the target schema; (vii) an encryption field, (viii) a repeat field; (ix) an overwrite field; and (x) retry attempts.

13. The system of claim 12, wherein the overwrite field is true and the at least one processor is further configured to:
create a copy of the data at the location at the transfer target system; and
replace the copy of the data with the encrypted source data at the transfer target system.

14. The system of claim 12, wherein the overwrite field is false, and wherein transferring the encrypted source data to the target data location causes the encrypted source data to be appended to the location at the transfer target system.

15. A non-transitory computer-readable device having instructions stored thereon that, when executed by at least one computing device, cause the at least one computing device to perform operations comprising:
receiving identification of a source data at a cluster system, wherein the source data is formatted according to a source schema;
receiving identification of a target data location, wherein the target data location includes an SQL database formatted according to a target schema;
validating, in real-time, the source schema and the target schema by comparing a field in the source schema to a field in the target schema;
in response to the validation, encrypting the source data; and
transferring the encrypted source data to the target data location.

16. The non-transitory computer-readable device of claim 15, wherein the source data is transferred using a pool of execution threads.

17. The non-transitory computer-readable device of claim 16, wherein a number of execution threads in the pool is based at least on a size of the data to be transferred, a type of data to be transferred, or a number of transfer target systems.

18. The non-transitory computer-readable device of claim 15, wherein validating the source scheme and the target schema fails, the operations further comprising:
applying an alias configured to match the field in the source schema to the field in the target schema.

19. The non-transitory computer-readable device of claim 15, the operations further comprising accessing a configuration file, the configuration file comprising: (i) a transfer source; (ii) identification of the source data at the transfer source system; (iii) the source schema; (iv) a transfer target; (v) a location at the transfer target system; (vi) the target schema; (vii) an encryption field, (viii) a repeat field; (ix) an overwrite field; and (x) retry attempts.

20. The non-transitory computer-readable device of claim 19, wherein the overwrite field is false, and wherein transferring the encrypted source data to the target data location causes the encrypted source data to be appended to the location at the transfer target system.
